(19) United States
(12) Patent Application Publication
(10) Pub. No.: US 2026/0158427 A1
(43) Pub. Date: Jun. 11, 2026

(54) FILTER INSERT LATCHABLE TO HOUSING COVER WITH SUPPORT ELEMENT FOR FILTER MEDIUM BODY

(71) Applicant: MANN+HUMMEL GmbH, Ludwigsburg (DE)

(72) Inventors: Pedro Miguel PEREIRA MADEIRA, Bietigheim-Bissingen (DE); Leos BURDA, Domasov U Brna (CZ); Daniel SCHMID, Sachsenheim (DE)

(21) Appl. No.: 19/411,637

(22) Filed: Dec. 8, 2025

Related U.S. Application Data
(63) Continuation of application No. PCT/EP2024/063210, filed on May 14, 2024.

(30) Foreign Application Priority Data
Jun. 6, 2023 (DE) 10 2023 114 761.7

(51) Int. Cl. B01D 46/00; B01D 46/12; B01D 46/16; B01D 46/62; H01M 8/0662

(52) U.S. Cl. CPC B01D 46/0005; B01D 46/0036; B01D 46/12; B01D 46/16; B01D 46/62; H01M 8/0687; B01D 2265/028; B01D 2271/027

(57) ABSTRACT

A filter insert has a filter medium body to be flowed through in flow direction from an inflow face to an outflow face. A support element held at the filter medium body has latches to latch the filter insert to a housing cover. A circumferential seal element is held at the support element. The support element has a grid section extending across the outflow face of the filter medium body. The grid section is integrally formed with the latches. A filter device has a filter housing with a housing cover with an inlet and a housing bottom part with an outlet. The housing cover has latches corresponding to the latches of the filter insert. In a mounted state of the filter device, a raw side in the filter housing is sealed relative to a clean side by the circumferential seal element of the filter insert arranged in the filter housing.

### CROSS-REFERENCE TO RELATED APPLICATIONS

This application is a continuation application of international application No. PCT/EP2024/063210 having an international filing date of May 14, 2024, and designating the United States, the international application claiming a priority date of Jun. 6, 2023 based on German patent application No. 10 2023 114 761.7, the entire contents of the aforesaid applications being incorporated herein by reference.

### BACKGROUND

The invention concerns a filter insert including at least one filter medium body which may be flowed through from an inflow face to an outflow face, a support element held at the filter medium body and including at least one first latching means by means of which the filter insert may be latched to a housing cover, and a circumferential seal element which is held at the support element.

Such a filter insert is disclosed in WO 2016/146250 A1.

Such filter inserts are used up to now for filtering combustion air of motor vehicles with an internal combustion engine. The latching action of the filter insert to the housing cover simplifies the exchange of the filter insert.

US 2010/0162673 A1 describes a filter device with a filter housing and a filter insert exchangeably arranged in the filter housing. A prefilter in the form of a cyclone separator is integrated in a housing cover of the filter housing. A filter medium body of the filter insert is surrounded near its inflow face by a support ring. The support ring includes tabs movable between a release position and a holding position. In the housing cover, cutouts are provided which the tabs engage in the holding position.

WO 2016/146250 A1 already mentioned before concerns a filter device, for example for a motor vehicle, with a filter element, which includes a filter medium which may be flowed through by a gas for filtering the gas, and with a housing including a housing cover and a filter receptacle in whose receiving space the filter medium may be at least partially received, and with at least one latching device for seal-tightly connecting housing cover, filter element, and filter receptacle. By means of the latching device, a top latching element on the part of the housing cover is connectable to a bottom latching element on the part of the filter receptacle by means of a connection element at the filter element. Top and bottom latching elements each are configured as a latching nose and the connection element as a top closure element and a bottom closure element, wherein each closure element includes a receptacle in which one of the latching noses is at least partially receivable in a latching position. The latching elements are embodied at a frame which surrounds the filter medium. Two seal elements are held at the frame which, in the closed state, contact a seal surface of the housing cover and of the housing receptacle, respectively. Since separate closure elements for the filter element and for the filter receptacle are provided at the housing cover, the opening sequence of the housing is not predetermined.

In the two aforementioned filter devices, relatively compact filter medium bodies are provided. They are held by the circumferential frame or support ring in the filter housing. For example in case of areally expansive or heavy filter medium bodies, a lateral fixation may be insufficient with respect to mechanical loads occurring in operation.

It is an object of the invention to improve the fixation of a filter insert that is exchangeable with minimal risk of dirt ingress to a clean side.

### SUMMARY

This object is solved by a filter insert, for example an air filter insert, including at least one filter medium body which may be flowed through from an inflow face to an outflow face; a support element held at the filter medium body and including at least one first latching means by means of which the filter insert may be latched to a housing cover; a circumferential seal element which is held at the support element; wherein the support element includes a grid section which extends across the outflow face of the filter medium body and which is integrally formed with the at least one first latching means.

This object is further solved by a filter device, for example an air filter device, including a filter housing which includes a housing cover with an inlet and a housing bottom part with an outlet; and a filter insert according to the invention; wherein the housing cover includes at least one second latching means which is configured corresponding to the at least one first latching means of the filter insert, and wherein a raw side in the filter housing is sealed in relation to a clean side by means of a seal element in the mounted state.

This object is further solved by a use of a filter insert according to the invention or a filter device according to the invention as a cathode air filter of a fuel cell.

This object is further solved by a fuel cell with an anode and a cathode between which an electrolyte is arranged and with a filter device according to the invention through which air may be guided to the cathode.

Embodiments are disclosed in the following description and accompanying drawings.

According to the invention, a filter insert is provided. The filter insert is in principle a gas filter insert, for example an air filter insert. The filter insert is, for example, used as a part of a filter device as described in the following.

The filter insert includes at least one filter medium body which may be flowed through from an inflow face to an outflow face. Typically, the filter medium body is cuboid and may be flowed through along its smallest expansion. The filter insert therefore may also be referred to as a flat filter. Such a filter medium body includes a minimal flow resistance while providing great separation performance and service life.

The filter insert includes furthermore a support element which is held at the filter medium body and includes at least one first latching means by means of which the filter insert is latchable to a housing cover. For an operation, the filter insert is latched to the housing cover, the housing cover being part of a filter housing. Through an inlet at the housing cover, gas to be filtered, for example air, may be guided to the inflow face of the filter medium body.

Furthermore, the filter insert includes a circumferential seal element that is held at the support element. In the mounted state with closed filter housing, the seal element may seal, on the one hand, the raw side in relation to a clean side (in other words, the inflow face in relation to the outflow face). A fluid flow must therefore pass through the filter medium body. On the other hand, the seal element may seal the housing cover in relation to the housing bottom part.

According to the invention, the support element includes a grid section which extends across the outflow face of the filter medium body and which is integrally formed with the at least one first latching means. The grid section rests typically against the outflow face or extends at a minimal distance, for example, of at most 2 mm, from the outflow face. By means of the grid section, the filter medium body is areally supported. At the same time, the grid section does not, or at most insignificantly, impair the flow through the filter medium body. Due to the integral embodiment of the support element provided with the grid section and of the at least one first latching means, the manufacture is simplified. The support element with the grid section and the at least one first latching means may be, for example, an injection molded plastic part. At the same time, the monolithic configuration of the support element effects a reliable fixation of the filter medium body at the housing cover. Since the filter insert is supported at the outflow face by the grid section and is latchable to the housing cover at the same time, it is avoided that dirt from the raw side (essentially between the inflow face and the inlet) may reach the clean side (in the housing bottom part) when opening the filter housing.

The at least one first latching means may include a latching nose. A latching means with a latching nose may be effectively manufactured and enables a reliable fixation as well as a simple release of the filter insert.

Typically, the first latching means is elastically deformable. The fixation and release of the filter insert at and from the housing cover is further simplified in this way.

Furthermore, the support element and for example the grid section are typically rigid. In this way, the support and fixation of the filter medium body are improved.

At least two first latching means each are formed at two oppositely positioned longitudinal sides of the filter insert. In this way, a particularly reliable fixation of the filter insert at the housing cover may be achieved. Typically, all first latching means at the support element are of the same kind.

The seal element may be held non-detachably at the support element, for example may be molded to the support element. By means of a non-detachable attachment, it is reliably prevented that the seal element is lost or slips during mounting. By molding, an efficient manufacture may be realized wherein the seal element is automatically connected to the support element during the manufacture.

The support element includes stays with intermediately positioned cutouts, wherein the seal element extends through the cutouts and engages around the stays. In this way, a particularly secure fixation of the, for example, molded-on seal element may be realized. The stays and cutouts form a receiving section for the seal element. This receiving section is also integrally formed with the grid section and the at least one first latching means.

A projecting seal edge may be formed at the seal element, for example, wherein the seal edge (in flow direction) projects past the outflow face. In the mounted state, the seal edge may seal-tightly contact a seal surface of the housing bottom part.

At the seal element, a contact surface for seal-tight contacting of a collar of the housing cover may be formed. The contact surface and the seal edge are typically arranged opposite each other. The seal element may then be clamped between the housing cover and the housing bottom part for a particularly reliable sealing action.

The at least one filter medium body and the support element may be held at each other by means of the seal element. The seal element fulfills thus a double function: on the one hand, it serves for sealing at the filter housing and, on the other hand, for connecting the components of the filter insert. This reduces the manufacturing expenditure.

The at least one filter medium body may be framed by a circumferential frame. The frame may seal the filter medium body at its side faces so that a flow from the inflow face to the outflow face may be forced.

The frame is embedded in the seal element. The frame thus procures the connection of the filter medium body to the seal element, respectively, the support element. Typically, the frame projects past the outflow face. In this way, the frame may be held particularly fast in the seal element.

The frame may consist of or be consisted of a nonwoven material. The frame is manufactured from a nonwoven strip. Nonwoven material is inexpensively available, easy to process, and sufficiently airtight.

As an alternative, the frame may be a plastic frame, for example an injection molded plastic part. This may simplify for example the fixation of several filter medium bodies.

The filter insert may include two filter medium bodies which may be flowed through in series. A first filter medium body includes a particle filtration medium and a second filter medium body an adsorption filter medium, for example containing active carbon. In this way, a particularly thorough cleaning of the air to be filtered may be achieved. Typically, the second filter medium body is arranged downstream of the first filter medium body. Adsorption filter media with active carbon are comparatively heavy so that a secure support action is particularly important, for example when the filter medium body has a large areal expansion. The grid section extends in principle at the outflow face of the downstream filter medium body.

Both filter medium bodies are held by the seal element at the support element. The aforementioned double function of the seal element is thus expanded to the fixation of the further filter medium body.

In a further embodiment, both filter medium bodies are framed by a common frame which is embedded in the seal element. The common frame may be a plastic frame, for example an injection molded plastic part. The common frame may be molded onto one of the filter medium bodies. The other filter medium body may be glued into the common frame. In this way, a particularly stable filter insert may be obtained.

In an alternative further embodiment, both filter medium bodies are framed by a circumferential frame, respectively, wherein at least one of the frames is embedded in the seal element. The frames may each include a nonwoven material, for example be manufactured of a nonwoven strip.

A first configuration of the filter insert is characterized in that the frame of the first filter medium body in flow direction extends at least to the outflow face of the second filter medium body in flow direction and in that the two frames are embedded in the seal element. The frame of the first filter medium body in flow direction projects past the outflow face of the second filter medium body in flow direction. Typically, the frame of the second filter medium body in flow direction projects also past the outflow face. This simplifies the fixation of the two frames in the seal element.

In an alternative embodiment, the two frames are glued to each other. This may be advantageous in regard to the required installation space transverse to the flow direction and reduce the material demand for the seal element and/or the frames.

The scope of the present invention also includes a filter device including:
a filter housing which includes a housing cover with an inlet and a housing bottom part with an outlet,
a filter insert in accordance with the invention as described above.

The filter device is in principle a gas filter device, for example an air filter device. In use, the housing bottom part is typically arranged below the housing cover; however, this is not mandatorily the case. For the illustration of the present invention independent of the arrangement in space—the housing part with the inlet is referred to as the housing cover and the housing part with the outlet as the housing bottom part. In the closed state, the housing cover and the housing bottom part enclose a receiving space in which the filter insert may be arranged. Through the inlet at the housing cover, air to be filtered may be guided to the inflow face of at least one filter medium body and filtered air may be discharged from the outflow face of the at least one filter medium body through the outlet at the housing bottom part.

The housing cover includes at least one second latching means which is embodied so as to correspond to the at least one first latching means of the filter insert. The filter insert may thus be latched to the housing cover. In this connection, the filter medium body is supported by means of the support element, for example its grid section, at the housing cover.

The housing cover and the housing bottom part are in principle connectable to each other in a detachable manner by means of connection means separate from the latching means. For example, the housing cover and the housing bottom part may be screw-connected to each other. Other connections are conceivable also. For example, elastic holding clamps may be provided in order to clamp the housing cover and the housing bottom part against each other.

In the mounted state, a raw side in the filter housing is sealed in relation to a clean side by means of the seal element. A leakage flow bypassing the filter medium body is thus prevented.

The inflow face of the filter medium body or of the upstream filter medium body is correlated with the raw side in the filter housing. The outflow face of the filter medium body or of the downstream filter medium body is correlated with the clean side in the filter housing.

When opening the filter housing, the filter insert remains initially fixed to the housing cover. A contact of the seal element at the housing cover remains intact as long as the filter insert is latched to the housing cover. Dirt which has collected at the raw side may thus not drop into the housing bottom part or reach the clean side. For an exchange of the filter insert, the latching action may be released and the filter insert may be removed from the housing cover. This is done expediently remote from the housing bottom part.

The second latching means may be formed with a perforation and an edge which delimits the perforation. For example, a latching nose of the first latching means may engage the perforation and be supported at the edge. A latching means with a perforation and an edge may be produced with particularly minimal expenditure and enables a secure connection. In addition, the perforation may facilitate the release of the latching action when exchanging the filter insert.

The second latching means may be rigid. This makes it possible to configure the housing cover to be rigid as a whole. The first latching means is then elastically deformable in order to be able to engage or disengage the second latching means.

The housing cover and the housing bottom part are sealed relative to each other by means of the seal element in the mounted state. The seal element then separates not only the raw side from the clean side but prevents in addition that air flows in the joint between the housing parts into the filter housing and out of the filter housing. The seal element is held by being clamped between the housing cover and the housing bottom part.

The housing cover may include a circumferential collar for contacting the seal element. The seal element may include a contact surface at which the collar rests seal-tightly in the mounted state.

The housing bottom part may include a circumferential seal surface to be contacted by the seal element. The seal element includes a seal edge for seal-tight contact at the seal surface.

It may be provided that the first latching means includes an outer leg and an inner leg. The housing bottom part may include a projection which engages between the legs when the housing cover with the filter insert is placed on the housing bottom part. This prevents unlatching of the filter insert when the housing is closed. The outer leg is linked via the inner leg to a receiving section for the seal element. The first latching means may be U-shaped or V-shaped in cross section.

The scope of the invention also includes a use of an above-described filter insert according to the invention, for example of a filter device according to the invention described above, as a cathode air filter of a fuel cell.

Finally, the invention concerns a fuel cell with an anode and a cathode, between which an electrolyte is arranged, and with an above-described filter device according to the invention through which air may be guided to the cathode.

In fuel cells, dirt ingress to the cathode must be reliably prevented. The filter device according to the invention enables this during the regular operation (because large filter medium bodies are securely supported at the grid section of the support element and the seal element effects a reliable separation of raw and clean sides) as well as when exchanging the filter insert (because the filter insert is fixed first to the housing cover and stays sealed in relation to it).

### BRIEF DESCRIPTION OF THE DRAWINGS

Further features and advantages of the invention result from the following detailed description of embodiments of the invention with the aid of the drawing figures illustrating details according to the invention. The aforementioned and still to be explained features may be realized each individually by themselves or several combined in arbitrary expedient combinations in variants of the invention. The features illustrated in the drawings are illustrated such that the particularities according to the invention may be made readily apparent.

FIG. 1 shows a first filter device according to the invention with a filter insert according to the invention in a schematic side view in the disassembled state.

FIG. 2 shows the filter insert of the filter device of FIG. 1 in a schematic perspective view.

FIG. 3 shows a schematic detailed view in a region of latching means of the filter device of FIG. 1.

FIG. 4 shows the filter device of FIG. 1 in a partially demounted state in a schematic side view.

FIG. 5 shows the filter device of FIG. 1 in a mounted state in a schematic side view.

FIG. 6 shows a further filter insert according to the invention with two filter medium bodies in a schematic section view.

FIG. 7 shows an enlarged detail of FIG. 6 in a region of a seal element.

FIG. 8 shows a schematic perspective view of the detail of FIG. 7, wherein the seal element is not illustrated.

FIG. 9 shows a filter device according to the invention with the filter insert of FIG. 6 in a schematic detail section view.

FIG. 10 shows a schematic diagram of a fuel cell according to the invention with a filter device according to the invention.

### DETAILED DESCRIPTION

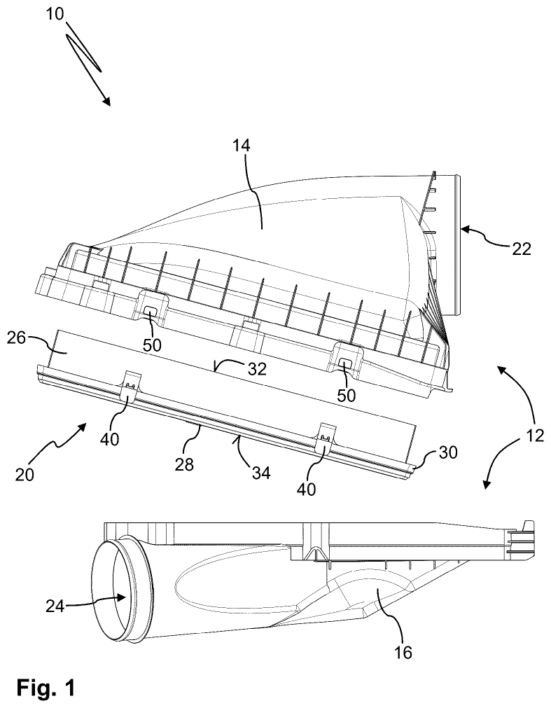

FIG. 1 shows a filter device 10 for filtering air in a disassembled state. The filter device 10 comprises a filter housing 12 which is formed by a housing cover 14 and a housing bottom part 16. Furthermore, the filter device 10 comprises a filter insert 20. At the housing cover 14, an inlet 22 for air to be filtered is provided. An outlet 24 for filtered air is provided at the housing bottom part 16.

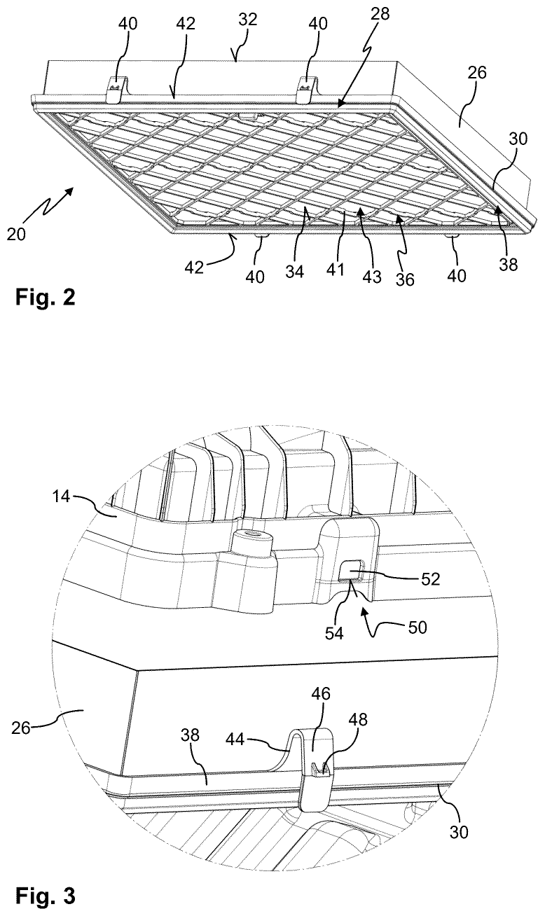

The filter insert 20 comprises a filter medium body 26, a support element 28, and a seal element 30, see also FIG. 2.

The filter medium body 26 may be flowed through from an inflow face 32 to an oppositely positioned outflow face 34. The filter medium body 26 is embodied here in a cuboid shape as a flat filter.

The support element 28 as a whole is formed as one piece and comprises a grid section 36, a frame-type receiving section 38, and first latching means 40, here four are shown as an example. The receiving section 38 extends circumferentially around the filter medium body 26. The seal element 30 is fastened to the receiving section 38. The grid section 36 spans the region which is enclosed by the receiving section 38. The outflow face 34 of the filter medium body 26 contacts the grid section 38. The grid section 38 is formed by ribs 41 which leave open flow openings 43. The ribs 41 extend here in a crossing arrangement. The ribs 41 may extend at a slant (as illustrated) or parallel or perpendicular to longitudinal sides 42 or transverse sides.

In the illustrated embodiment, the first latching means 40 are arranged in pairs at oppositely positioned longitudinal sides 42. The first latching means 40 project away from the receiving section 38. They extend here as a whole in a U-shape, wherein an inner leg 44 is joined to the receiving section 38 and an outer leg 46 supports a latching nose 48, see FIG. 3. The outer leg 46 with the latching nose 48 may be deflected toward the inner leg 44 or the filter medium body 26.

Second latching means 50 corresponding to the first latching means 40 of the filter insert 20 are provided at the housing cover 14. The second latching means 50 are each provided with a perforation 52 which is delimited toward the housing bottom part 16 by an edge 54.

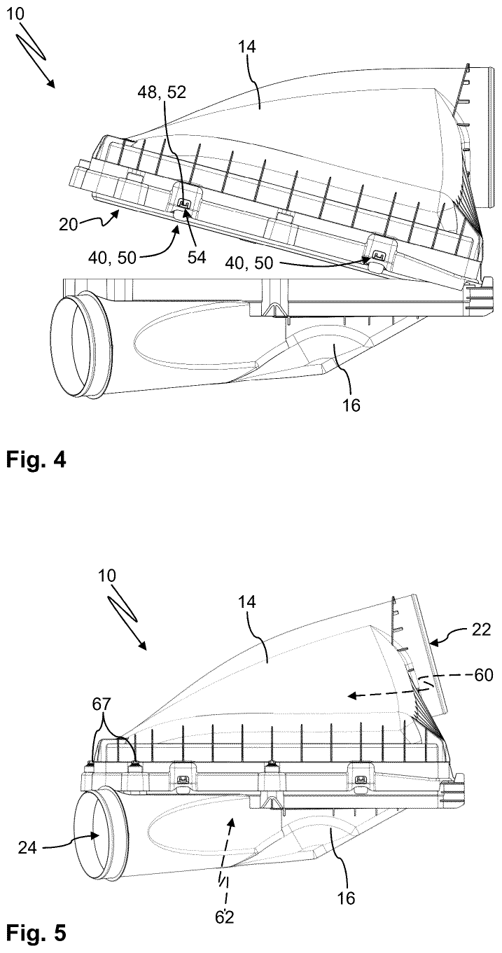

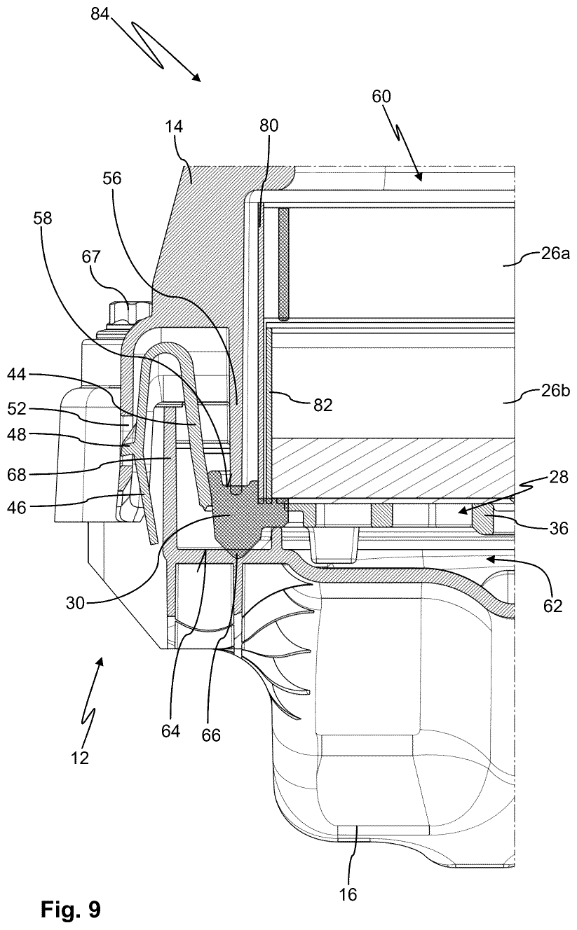

When the filter insert 20 is held at the housing cover 14, the latching noses 48 project into the perforations 52 and engage behind the edges 54, compare FIG. 4. In this partially mounted state, the seal element 30 contacts circumferentially the housing cover 14. In this context, a circumferential collar 56 of the housing cover 30 may rest on a contact surface 58 of the seal element 30 (hidden in FIG. 4, compare FIG. 9).

In the closed state of the filter housing 12, compare FIG. 5, the filter insert 20 separates a raw side 60 correlated with the inlet 22 from a clean side 62 correlated with the outlet 24. The seal element 30 is positioned in this context seal-tightly at the collar 56 of the housing cover 14 as well as also at a seal surface 64 of the housing bottom part 16 (hidden in FIG. 5, compare again FIG. 9). For contacting the seal surface 64, the seal element 30 may comprise a seal edge 66. Thus, the seal element 30 seals the two housing parts 14, 16 relative to each other as well as the raw side 60 in relation to the clean side 62.

The two housing parts 14, 16 may be fixed to each other in the closed state by screws 67, see FIG. 5. A projection 68 of the housing bottom part 16 may engage between the legs 44, 46 of the first latching means 40 in the closed state of the filter housing 12 and prevent unlatching of the latching means 40, 50, compare FIG. 9.

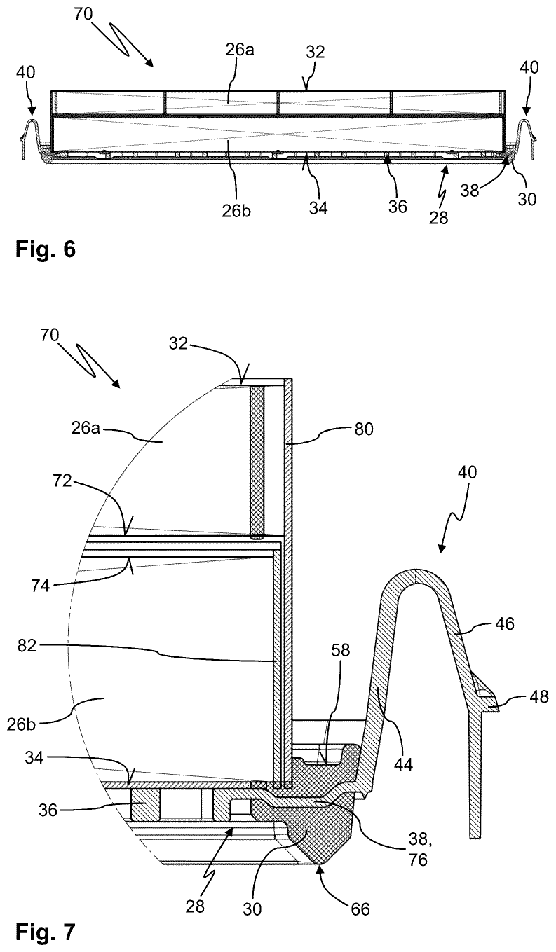

FIG. 6 shows a further filter insert 70. The filter insert 70 comprises two filter medium bodies 26a, 26b which may be flowed through one after another (serially). The first filter medium body 26a in flow direction may be obtained from a particle filtration medium, for example, folded filter paper. The second filter medium body 26b in flow direction may be obtained from an adsorption medium and may contain active carbon. The filter medium bodies 26a, 26b connected in series may be flowed through from an inflow face 32 at the first filter medium body 26a to an outflow face 34 at the second filter medium body 26b. In this context, the air exits at an intermediate outflow face 72 from the first filter medium body 26a and enters at an intermediate inflow face 74 the second filter medium body 26b, compare also FIG. 7.

A support element 28 of the filter insert 70 is embodied substantially as described above. For example, a grid section 36 of the support element 28 extends at the outflow face 34. First latching means 40 project away from a frame-type receiving section 38 of the support element 28.

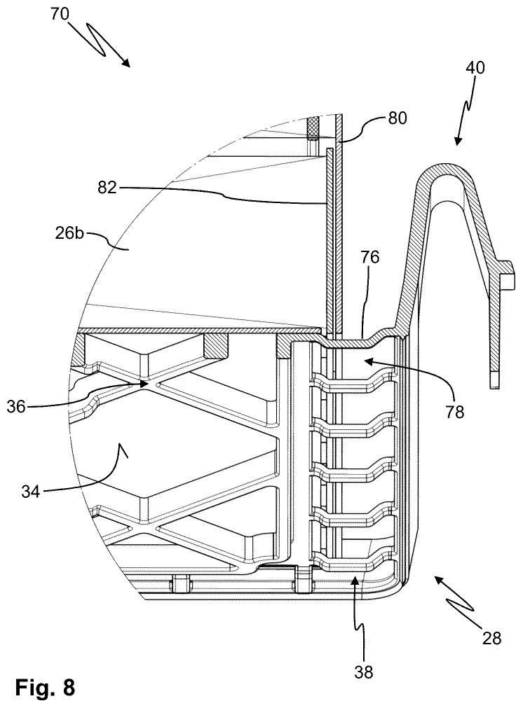

A seal element 30 is non-detachably held at the receiving section 38. The seal element 30 is also substantially designed as described above. Presently, the seal element 30 is molded onto the support element 28. The receiving section 38 is formed with stays 76 and cutouts 78, compare also FIG. 8 in which the seal element 30 is not illustrated. The seal element 30 extends through the cutouts 78 and encloses the stays 76, compare for example FIG. 7.

The two filter medium bodies 26a, 26b are each framed by a circumferential frame 80 or 82, compare for example FIG. 7. The frames 80, 82 seal lateral surfaces of the filter medium bodies 26a, 26b and may be comprised of nonwoven material. The frames 80, 82 may be glued to the respective filter medium body 26a, 26b.

The frame 80 of the first filter medium body 26a projects significantly past its intermediate outflow face 72 and extends past the outflow face 34 at the second filter medium body 26b. A width of the frame 80 is somewhat larger than the width of the frame 82 so that the second filter medium body 26b may be inserted into the first frame 80. The frame 82 of the second filter medium body 26b also projects somewhat past the outflow face 34.

In their respective end regions at the outflow face 34, the two frames 80, 82 are embedded in the seal element 30. The two filter medium bodies 26a, 26b are thus fastened by means of the seal element 30 (and their respective frames 80, 82) to the support element 28. For this purpose, the seal element 30 is molded onto the support element 28 and the two filter medium bodies 26a, 26b with their frames 80, 82 when the latter are prepositioned at the support element 28.

As an alternative, it would also be conceivable to glue a frame of the first filter medium body 26a to a frame of the second filter medium body 26b and to embed only the frame of the second filter medium body 26b in the seal element 30 (not illustrated in detail).

It would also be possible to provide a common frame for both filter medium bodies 26a, 26b and embed it in the seal element 30 (also not illustrated in detail). The common frame could be glued to one or both filter medium bodies or could be injection molded as an injection molded plastic part to one of the filter medium bodies and glued to the other filter medium body.

FIG. 9 shows a filter device 84 with the filter insert 70. A filter housing 12 of the filter device 84 is formed with a housing cover 14 and a housing bottom part 16, as described above. The two housing parts 14, 16 and a raw side 60 correlated with an inlet at the housing cover 14 as well as a clean side 62 correlated with an outlet at the housing bottom part 16 are sealed relative to each other by means of the seal element 30, also as described above. The filter device 84 differs from the filter device 10 essentially by using the filter insert 70 with two filter medium bodies 26a, 26b instead of the filter insert 20 with a single filter medium body 26 and a correspondingly adjusted dimensioning of the housing cover 14 for receiving the two filter medium bodies 26a, 26b.

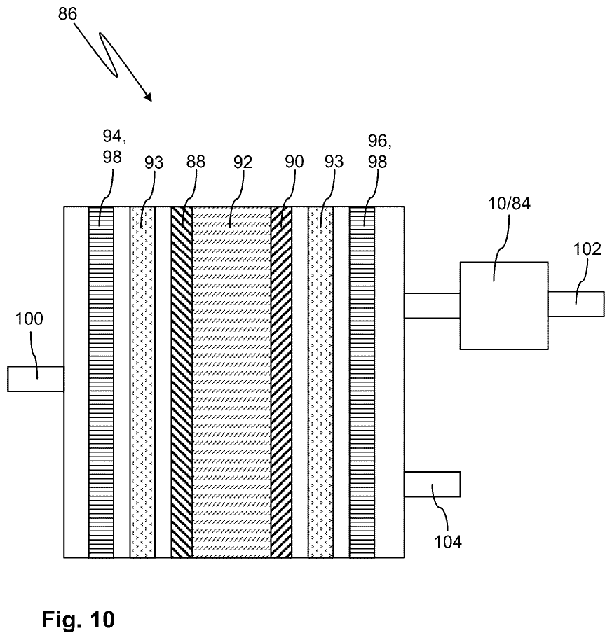

FIG. 10 shows a fuel cell 86. The fuel cell 86 comprises an anode 88, a cathode 90, and an electrolyte 92 arranged therebetween. The anode 88 and the cathode 90 may adjoin outwardly a gas diffusion layer 93, respectively. The anode 88 and the cathode 90 may be received between lateral parts 94, 96 of a bipolar plate 98. Through the lateral part 94 of the bipolar plate 98, hydrogen may be guided from a hydrogen inlet 100 to the anode 88. Through the lateral part 96 of the bipolar plate 98, oxygen or oxygen-containing air from an air inlet 102 may be guided to the cathode 90. Between the air inlet 102 and the cathode 90 a filter device, for example, the above-described filter device 10 or 84, is arranged. The filter device 10 or 84 functions thus as a cathode air filter. Water produced in the fuel cell 86 may be discharged through a water outlet 104. Electrical connections of the fuel cell 86 are not illustrated in detail.

In summarizing, the invention concerns a filter insert with at least one filter medium body. At the outflow face, the filter insert is supported by a grid section of a support element. The grid section comprises areal flow openings and is, for example, formed by ribs crossing each other. The support element comprises at least one latching means which is integrally formed with the grid section and by means of which the filter insert may be latched to a housing cover of a filter device. At the support element, a seal element is held which seals the filter insert in relation to the housing cover in the latched state. When opening a filter housing, the filter insert stays secured at the housing cover due to the latching action. Dirt collected at the raw side (between the filter insert and the housing cover) thus does not reach a housing bottom part with a clean-side outlet.

### Reference Characters

filter device 10; 84
filter housing 12
housing cover 14
housing bottom part 16
filter insert 20; 70
inlet 22
outlet 24
filter medium body 26; 26a, 26b
support element 28
seal element 30
inflow face 32
outflow face 34
grid section 36
receiving section 38
first latching means 40
ribs 41
longitudinal sides 42
flow openings 43
inner leg 44
outer leg 46
latching nose 48
second latching means 50
perforation 52
edge 54
collar 56
contact surface 58
raw side 60
clean side 62
seal surface 64
seal edge 66
screws 67
projection 68
intermediate outflow face 72
intermediate inflow face 74
stays 76
cutouts 78
frame 80 of the first filter medium body 26a
frame 82 of the second filter medium body 26b
fuel cell 86
anode 88
cathode 90
electrolyte 92
gas diffusion layer 93
lateral parts 94, 96
bipolar plate 98
hydrogen inlet 100
air inlet 102
water outlet 104

That which is claimed is:

1. A filter insert comprising:
a first filter medium body comprising an inflow face and an outflow face and configured to be flowed through in a flow direction from the inflow face to the outflow face;
a support element held at the first filter medium body and comprising one or more first latching means configured to latch the filter insert to a housing cover;
a circumferential seal element held at the support element;
wherein the support element comprises a grid section extending across the outflow face of the first filter medium body; and
wherein the grid section is integrally formed with the one or more first latching means.

2. The filter insert according to claim 1, wherein the one or more first latching means each comprise a latching nose.

3. The filter insert according to claim 1, wherein the one or more first latching means include at least two first latching means formed at a first longitudinal side of the filter insert and further include at least two first latching means formed at a second longitudinal side of the filter insert, wherein the second longitudinal side of the filter insert is oppositely positioned to the first longitudinal side of the filter insert.

4. The filter insert according to claim 1, wherein the circumferential seal element is held non-detachably at the support element.

5. The filter insert according to claim 4, wherein the support element comprises stays and cutouts intermediately positioned between the stays, wherein the circumferential seal element extends through the intermediately positioned cutouts and engages around the stays.

6. The filter insert according to claim 1, wherein the first filter medium body and the support element are held at each other by the seal element.

7. The filter insert according to claim 6, further comprising a circumferential frame framing the first filter medium body, wherein the circumferential frame is embedded in the circumferential seal element.

8. The filter insert according to claim 1, further comprising a second filter medium body, wherein the first filter medium body and the second filter medium body are arranged so as to be flowed through serially, wherein one of the first filter medium body and the second filter medium body comprises a particle filtration medium and the other one of the first filter medium body and the second filter medium body comprises an adsorption filter medium.

9. The filter insert according to claim 8, wherein the first filter medium body and the second filter medium body are held by the circumferential seal element at the support element.

10. The filter insert according to claim 9, wherein the first filter medium body is framed by a first circumferential frame and the second filter medium body is framed by a second circumferential frame, wherein at least one of the first circumferential frame and the second circumferential frame is embedded in the circumferential seal element.

11. The filter insert according to claim 9, wherein one of the first filter medium body and the second filter medium body is an upstream filter medium body in the flow direction and comprises a circumferential frame and wherein the other one of the first filter medium body and the second filter medium body is a downstream filter medium body in the flow direction and comprises a circumferential frame, wherein the circumferential frame of the upstream filter medium body extends at least to the outflow face of the downstream filter medium body in the flow direction, and wherein the circumferential frame of the upstream filter medium body and the circumferential frame of the downstream filter medium body are embedded in the circumferential seal element.

12. A filter device comprising:
a filter housing comprising a housing cover with an inlet and a housing bottom part with an outlet;
a filter insert according to claim 1 configured to be arranged in the filter housing;
wherein the housing cover comprises one or more second latching means configured to correspond to the one or more first latching means of the filter insert;
wherein a raw side in the filter housing is sealed in relation to a clean side in the filter housing by the circumferential seal element of the filter insert in a mounted state of the filter device.

13. The filter device according to claim 12, wherein the one or more second latching means each are formed by a perforation and an edge delimiting the perforation.

14. The filter device according to claim 12, wherein the housing cover and the housing bottom part are sealed relative to each other by the circumferential seal element of the filter insert in the mounted state of the filter device.

15. The filter device according to claim 12, wherein the housing cover comprises a circumferential collar configured to contact the circumferential seal element of the filter insert and the housing bottom part comprises a circumferential seal surface configured to be contacted by the circumferential seal element of the filter insert.

16. The filter device according to claim 12, wherein the housing cover comprises a circumferential collar configured to contact the circumferential seal element of the filter insert.

17. The filter device according to claim 12, wherein the housing bottom part comprises a circumferential seal surface configured to be contacted by the circumferential seal element of the filter insert.

18. The filter device according to claim 12, wherein the filter device is a cathode air filter of a fuel cell.

19. A fuel cell comprising:
an anode and a cathode;
an electrolyte arranged between the anode and the cathode;
a filter device according to claim 12, wherein air is guided to the cathode via the filter device.

20. A method of filtering cathode air for a fuel cell, the method comprising using a filter insert according to claim 1 in a cathode air filter of the fuel cell.
